(19) United States
(12) Patent Application Publication
(10) Pub. No.: US 2015/0227956 A1
(43) Pub. Date: Aug. 13, 2015

(54) UNIPONS

(71) Applicant: JEFFREY W. McCOWIN, MEDINA, OH (US)

(72) Inventor: JEFFREY W. McCOWIN, MEDINA, OH (US)

(21) Appl. No.: 14/090,121

(22) Filed: Feb. 12, 2014

(51) Int. Cl. G06Q 30/02

(52) U.S. Cl. CPC G06Q 30/0224

(57) ABSTRACT

A system which provides information to customers in various ways about a discount a Brand is offering to purchase a product. Once the customer chooses a discount offer, instead of having multiple coupons to purchase different products, the customer only needs one coupon in each case to purchase the item and receive the discount. Once a customer has a UNIPONS coupon, the customer has the capability of purchasing any coupon offer provided through UNIPONS using the single UNIPONS coupon method. UNIPONS coupons are distributed through the UNIPONS website database, the Ecommerce site and Retail stores.

System and method for providing consumers the ability to use one coupon for all coupon offers and discounts on the internet and retail environment.

### BACKGROUND OF THE INVENTION

1. Field of the Invention

This relates to a system and method for providing consumers the ability to use one coupon for all coupon offers and discounts on the internet and retail environment

2. Description of the Related Art

This system creates an innovative way for customers to validate and use coupons. Instead of having to cut out coupons or enter different promo codes, UNIPONS allows the customer to have one universal coupon that will work for all coupon offers. This unique concept will take the burden off the consumer to keep track of multiple coupons accumulated from advertising material. Now the consumer can concentrate on finding the product and discount they are seeking. Then all the consumer has to do is apply a single coupon for any discount they apply to a purchase. That is what makes this system so unique.

### SUMMARY OF THE INVENTION

One embodiment of the invention is a UNIPONS website (not shown) that provides information to customers who are looking for a coupon deal prior to making a purchase. Customers have access through the UNIPONS website via the search engine located in the site to find coupons desired. Customers can search through Categories, Sub Categories, Brands, Names of Products, and Model # of Products while customer is placing information about a item being searched. A dropbox will come down from while the information provided is typed in giving the Customer options to choose from given the initial data entered.

Another embodiment of the invention is a system that provides the Customer access to the same information on any Ecommerce site that is participating in the coupon process. While the Customer is on a Ecommerce site, a Customer can search for coupons through a search engine provided on that site. The UNIPONS search engine is also available for access on individual Ecommerce sites. Retail and Ecommerce has access through API services to UNIPONS' database engine for all coupon offers available provided by Brands. A UNIPONS search with drop down box on Ecommerce sites. Customers can search UNIPONS for coupons while searching Ecommerce sites. The site is linked with UNIPONS through API. Then Customer enters UNIPONS in the DISCOUNT/PROMO CODE box to receive their discount on items purchased prior to checkout. This is the unique feature of the UNIPONS “ONE COUPON FOR ALL” technique. Whenever a Customer wants to activate a coupon provided through UNIPONS, all they have to do is type in UNIPONS to receive any and all coupons offered through UNIPONS. There are three ways a Customer can create the discount event at a Retailer. A Customer can ‘say’ UNIPONS, produce a card with UNIPONS on it, or use their mobile device with the UNIPONS coupon on it. There are two ways a Customer can create a discount event on a Ecommerce site. A Customer can use their computer and type in UNIPONS in the DISCOUNT/PROMO code box or use their mobile device and use the same method.

Yet another embodiment of the invention is that the Brands can go to the UNIPONS website and click UNIPONS FOR BRANDS. A Brand can login to their account. Then they can upload a ‘coupon deal’ that will be offered through UNIPONS website and entered into the UNIPONS database. The database can be retrieved by Retailers and Ecommerce through API. They can upload data via MS excel file or CSV. They can also download any coupon deals from the UNIP9NS database through the UNIPONS XML feed.

The Retailers/Ecommerce people can also go to the UNIPONS website. There they can click on the UNIPONS FOR RETAILERS. They can download from the UNIPONS' deal list all appropriate coupon offers via MS EXCEL or CSV files, or XML feed.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a view that illustrates how the new coupon and discounting process system works.

FIG. 2 is an illustration of the process how ‘One Coupon For All’ system functions as part of the invention along the line 200 in FIG. 1.

FIG. 3 is an illustration of how the discount event is achieved through the process of information viewed along the line 300 in FIG. 1.

FIG. 4 is a view that illustrates the database structure of criteria and the information once accumulated as viewed along the line 400 in FIG. 3

FIG. 5 is a perspective view of an embodiment of the invention as viewed along the line 500 in FIG. 1.

FIG. 6 is a perspective view of an embodiment of the invention as viewed along the line 600 in FIG. 1.

FIG. 7 is a perspective view of an embodiment of the invention as viewed along the line 700 in FIG. 1.

FIG. 8 is a perspective view of an embodiment of the invention as viewed along the line 800 in FIG. 1.

### DETAILED DESCRIPTION OF THE PREFERRED EMBODIMENT(S)

Various embodiments of the invention are described hereinafter are represented by reference numbers throughout the figures. The figures are only intended to help describe the invention. References will be made to the numbers of the elements of like structures or functions of the invention. In addition, an aspect described in conjunction with a particular function or embodiment of the invention is not necessarily limited to that embodiment and can be practiced in conjunction with any other embodiments of the invention.

The inventors have discovered that many potential sales are not finalized in the Ecommerce and Retail markets primarily because of the inconvenience of physical coupons are a hassle to clip, store, and then use at point of sale. Having a ‘One Coupon For All’ solves that ongoing problem.

The inventors further realize that having a ‘One Coupon For All’ solves that ongoing problem. It eliminates the prevailing problem that exists today.

Simultaneously, manufacturers of Brands will have a extreme reduction in advertising costs. They will have a one-stop place to promote their products and display coupons, which will dramatically lower their advertising and promotional costs.

In addition, Retailers and Ecommerce sites will experience an increase in sales. Coupon use will become easier which will facilitate use, and thereby increase sales.

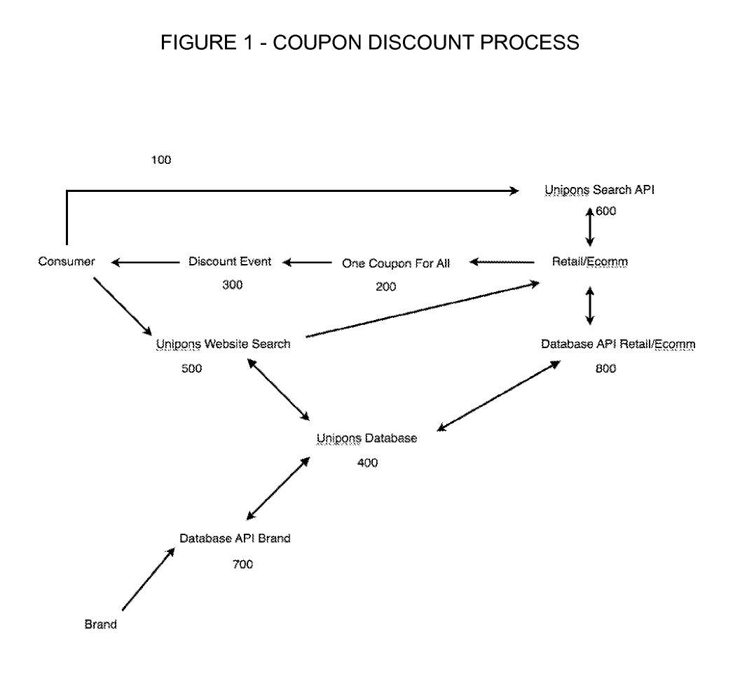

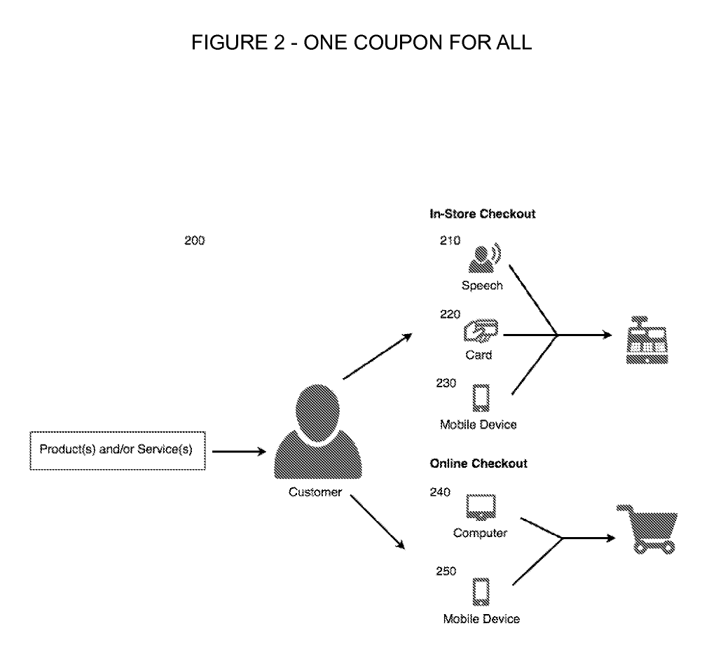

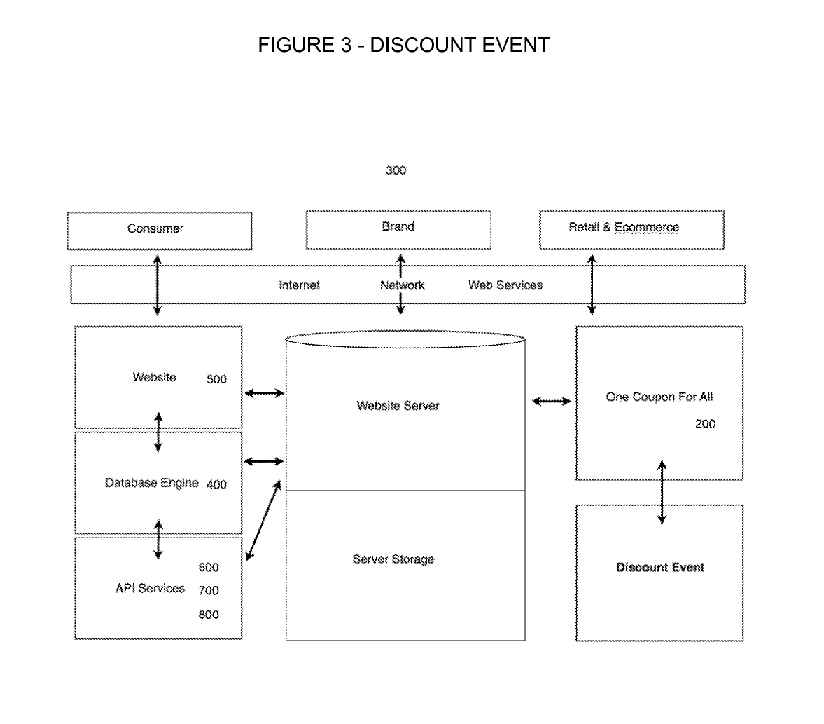

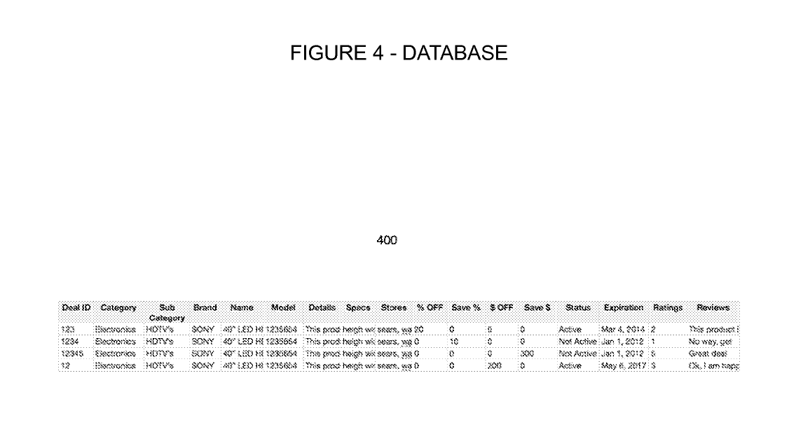

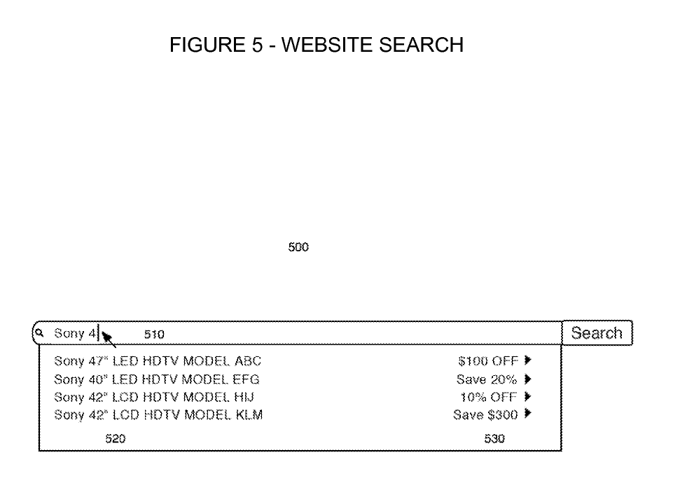

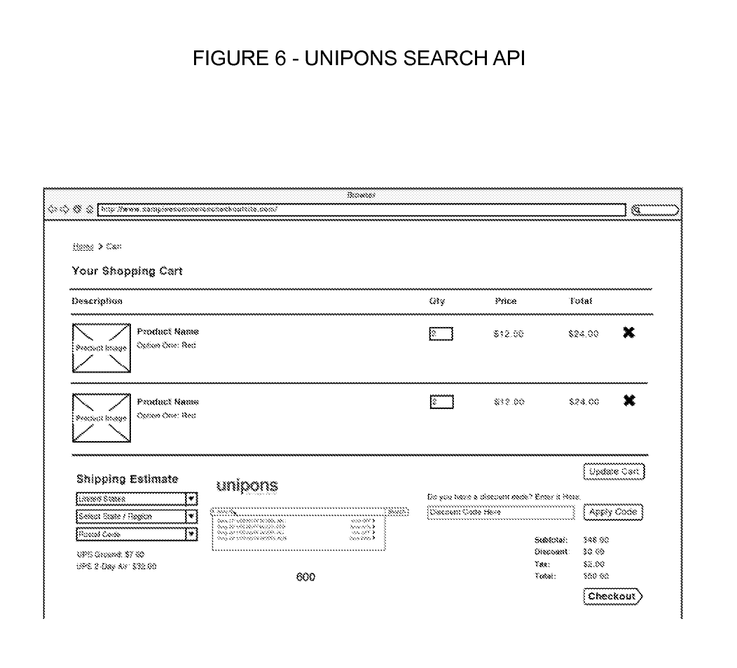

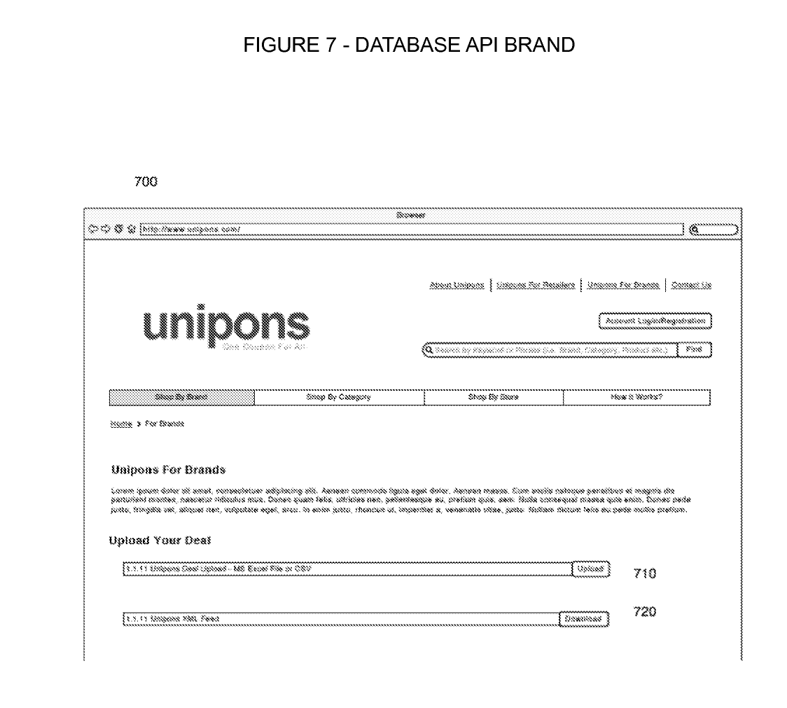

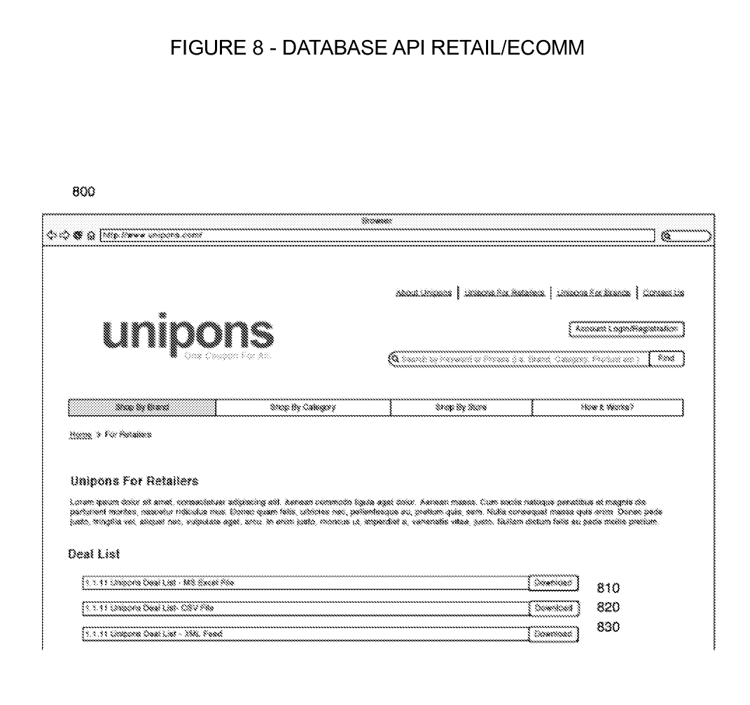

1. Referring to FIG. 1. This is the Coupon Discount Process. This is an overview of system 100 that depicts how the coupon and discounting process system works. This reveals the system of how ‘one coupon’ can replace and represent a multitude of coupons that were previously used for discounts. In system 100, a customer will generate a coupon by various means. One method of generating a coupon is by a customer using UNIPONS search 600 FIG. 6. This is located on the Ecommerce site. The customer by using a computer or mobile device would access a Ecommerce site. Once there, the customer would find a UNIPONS search engine and type in the Brand or Model, etc. that the customer is seeking. A coupon can then be chosen to purchase an item for a discount. The search engine would then (via API 800 FIG. 8) access the UNIPONS DATABASE 400 FIG. 4 to give the consumer the desired information. The search engine would possess a drop down box to facilitate the search. The information the customer receives will be populated from the UNIPONS DATABASE 400 FIG. 4. Once the customer finds the appropriate coupon that is sought, and knows that a particular item has a coupon offer on it, then the customer places the universal coupon code UNIPONS into the PROMO CODE/COUPON box. Then the customer will click on ‘calculate cost’ button on the Ecommerce site, and the appropriate discount will be applied at checkout, which is the discount event 300 FIG. 3 for the Customer. Another method of generating a coupon is through UNIPONS DATABASE 500 FIG. 5. This is located at the UNIPONS.COM website. The search engine located at this site is populated by the UNIPONS DATABASE 400 FIG. 4. The Customer types in model, brand, category, etc. into the search engine. A drop down box will appear to facilitate the search by the Customer. Once the Customer finds a desirable coupon(s) of choice, the Customer can then apply that coupon 200 FIG. 2 at a Ecommerce site or Retail establishment using the name, word, or card, by stating or typing in UNIPONS (One Coupon For All 200 FIG. 2). The Ecommerce/Retail locations will already have the coupon information downloaded into their system from the UNIPONS DATABASE 400 FIG. 4. The Retailers/Ecommerce sites achieve this download through the API 800 FIG. 8. The Retailers/Ecommerce sites will be able to download an excel file 810, CSV file 820, or an automized XML feed 830 (referring to FIG. 8) to gain access to all of the coupon deals in the UNIPONS DATABASE 400 FIG. 4. This is another example of the discount event 300 FIG. 3 for the Customer. The information about each individual coupon that has been downloaded 800 FIG. 8 into their individual systems by the Retail/Ecommerce sites will be updated as frequently as possible to assure the accuracy and timing of each individual coupon. Brands will issue coupons and upload 700 FIG. 7 to the UNIPONS DATABASE 400 FIG. 4. This is our API for Brands. This enables Brands to upload their current coupon offers by loading an Excel/CSV file 710 FIG. 7 or by utilizing our automized XML feed 720 (FIG. 7) which will then write to UNIPONS DATABASE 400 FIG. 4.

2. On to FIG. 2 This is an explanation of the process how ‘One Coupon For All’ system 200 functions. Within this system, there are two places where a Customer will use a coupon for a discount on the cost of their purchase price for an item purchased. At the In-Store Retail Checkout Counter, the Customer has 3 options to validate a coupon to receive a discount on the price of an item(s) purchased. The first way is when a Customer says (Speech) “UNIPONS” to the cashier at the register 210. When the Customer uses this audible method, the cashier would then enter UNIPONS into the retail system to achieve the ‘ONE COUPON FOR ALL’ coupon discount on any item purchased that would correspond to a coupon entered into the Retail computer system achieved through 810, 820, or 830 FIG. 8. The second way is when a Customer is carrying a UNIPONS DISCOUNT CARD. This unique method of the Customer producing a discount card 220 to show a cashier at the checkout counter is equivalent to a Customer carrying a pocket full of coupons around in their pocket or purse. This is due to the fact that the discount card represents all of the coupons offered by the Brands and stored in the UNIPONS DATABASE 400 FIG. 4. This is the essence of ONE COUPON FOR ALL and works in all instances in FIG. 2. The third way ONE COUPON FOR ALL works in a Retail Store is by using a Mobile Device 230. This is achieved by the Customer downloading a coupon from UNIPONS.COM from their Mobile Device 230 and showing it to the cashier at the checkout counter at the Retail Store while making a purchase. The Retail clerk then enters UNIPONS into their system prior to purchase. The Customer then receives the discounted price on the item(s) purchased 230. In addition, when the Customer goes on the internet using a Computer 240 to an Ecommerce site, the ONE COUPON FOR ALL works just as easily. First the Customer acquires a coupon offer from UNIPONS. This is achieved by two methods. First by going onto the UNIPONS.COM website and searching for the desired coupon(s) wanted through the UNIPONS WEBSITE SEARCH 500 FIG. 5. The second method is by searching for a coupon(s) via the API Ecommerce site search 600 FIG. 6. Once a Customer obtains a coupon(s) through one of the above methods, the Customer then enters ‘UNIPONS’ into the discount section of an Ecommerce site to receive the discount(s) desired. Once entered into the discount section, the Ecommerce site will apply all available discounts to the item(s) in their cart 240. Using the method Mobile Device 250 works identical to the Computer method 240 above with the exception that the Customer uses a Mobile Device 250 to access the internet and Ecommerce site instead of a non-mobile Computer. The difference between the methods of 240 and 250 is the normal limited mobility of a Computer 240.

3. Referring to FIG. 3, this shows how the DISCOUNT EVENT 300 is achieved through the flow chart 300. Definitions: The Consumer is the Retail/Ecommerce Customer. The Brand is the offerer of the coupon(s) offered to the public. Retail/Ecommerce are the businesses who accept the coupons/discounts and apply them to the price of a product/service offered by the Brands when a purchase is made. The Internet/Network/Web Services are already in existence and are all used to facilitate communication and the flow of information. Initially, the Website Server helps to input through API Services 700 FIG. 7 information being distributed by the Brands regarding coupon(s) being offered to potential Customers/Consumers. That information will be saved and stored in the Server Storage and referred to as the UNIPONS DATABASE. The information is stored in the UNIPONS DATABASE in the format as disclosed in 400 FIG. 4. Once the Database coupon information is stored, it is ready to be distributed in a variety of ways. 1) One distribution method is for the UNIPONS DATABASE stored in the Server Storage to be accessed by the Retail/Ecommerce group. This is achieved by the Retail/Ecommerce downloading the UNIPONS DATABASE through the Website Server via the API Services 800 FIG. 8. 2) A second way the UNIPONS DATABASE is accessed by Customers is through the Website Search 500 FIG. 5. The search results are gathered from the information stored in the UNIPONS DATABASE and provided by the Database Engine 400 FIG. 4 through the Website Server. 3) A third way the UNIPONS DATABASE information is accessed by Customers/Consumers is through the Website Server via the API Services 600 FIG. 6. Once a potential Customer acquires a coupon(s) through 2) or 3), now is the time for the redemption process ONE COUPON FOR ALL 200 FIG. 2.

The Customer then uses the various methods in 200 FIG. 2 to validate the coupon and receive the Discount Event 300 at time of purchase.

4. On to FIG. 4. This is the database structure of the criteria demonstrating how the UNIPONS DATABASE 400 FIG. 4 accumulates and stores information. This is UNIPONS central location database illustrating all products and discount coupons offered through the UNIPONS system. All data provided to the UNIPONS.COM Website Search 500 FIG. 5 or the API ECommerce site search 600 FIG. 6 is obtained from the UNIPONS DATABASE through the Website Server via the DATABASE ENGINE 400 FIG. 4.

5. Next is FIG. 5, the UNIPONS.COM Website Search 500. When a Customer enters the UNIPONS.COM website, the Customer can access all coupon/discount offers available by searching for them on the Website Search. When a Customer starts typing in search requests in the search bar 510, whether it is general product information or specific Brand information, the Website Search will autocomplete different product choices 520 in the drop down box. This gives the Customer the capability to be able to choose different coupons in specific areas that the Customer is searching for. In addition, in the autocomplete drop down box, information listed in 510 will have specific coupon/deal offers associated with each item 530. This data is being retrieved from the UNIPONS DATABASE 400 FIG. 4.

6. Referring to FIG. 6, the UNIPONS Site Search API 600. This feature is located on Ecommerce sites. It is the same search as the Website Search 500 FIG. 5. Customers will have the opportunity to search the UNIPONS DATABASE 400 FIG. 4 looking for a coupon(s) while on all participating Ecommerce sites. Customers can search for coupon deals without leaving the Ecommerce site. FIG. 6 is an example of what the API Site Search API would look like on an Ecommerce site. Again, once the Customer found a coupon(s) offer that the Customer wanted to use to make a purchase, the Customer would type in UNIPONS in the discount code box. This is the essence and unique feature of this process.

7. FIG. 7 As referred to in #1 above, this is UNIPONS API for Brands 700. The Brands will create a coupon for distribution. Then the Brands have the opportunity to upload the coupon(s) created by either loading an Excel/CSV file 710 or by utilizing our automized XML feed 720 FIG. 7. The information loaded will then write to UNIPONS DATABASE 400 FIG. 4.

8. FIG. 8 As referred to in #1 above, this is UNIPONS API for Retailers/Ecommerce sites 800. Once the Brands upload the coupon(s) they are offering, the Retailer/Ecommerce sites will have the capacity to download all the Brand's offers/discounts via an excel file 810, CSV file 820, or automized XML feed 830 FIG. 8 to gain access to all of the deals in our UNIPONS DATABASE 400 FIG. 4.

What is claimed as being new and to protected by Letters Patent of the U.S. is as follows:

1. This is a new and improved system whereby all coupon offers issued by a grantor of a coupon (Brand) are represented by a single coupon that represents all discounts offered by the Brands. One coupon for all coupons.

2. This system creates a new and innovative way for customers to use and validate a discount which consists of: Instead of Customers cutting out coupons or using promo codes, this system allows the customer to have one universal coupon that will work for all coupon offers.

3. Provides a new and improved website method where customers can find coupon offers and they only need one coupon for Retailers and Ecommerce to validate all coupons offered by Brands.

4. Provides a new and improved way for Brands to download coupon offers into a database on the website and Retailers and Ecommerce sites can access that information to give customers discounts offered by Brands.

5. Provides a new and innovative way that provides a method for Brands to offer multiple discounts represented by only one coupon.

6. Provides a new and innovative way that allows Retailers and Ecommerce Sites to redeem multiple discounts using only one coupon.
